(19) United States
(12) Patent Application Publication
(10) Pub. No.: US 2023/0211766 A1
(43) Pub. Date: Jul. 6, 2023

(54) DETERMINATION OF BRAKE FLUID LIFE BASED ON CONTINUOUS LEVEL AND QUALITY MEASUREMENTS

(71) Applicant: GM Global Technology Operations LLC, Detroit, MI (US)

(72) Inventors: Hung Huu Nguyen, Toronto (CA); Frances Helen Tenney, Markham (CA); Steven J. Weber, Shelby Township, MI (US)

(21) Appl. No.: 17/569,029

(22) Filed: Jan. 5, 2022

(51) Int. Cl. B60T 17/22; F16D 66/02

(52) U.S. Cl. CPC B60T 17/22; B60T 17/221; F16D 66/02; F16D 2066/001

(57) ABSTRACT

A vehicle includes a system and a method of monitoring a condition of a brake fluid. The system includes a first sensor configured to measure a fluid level of the brake fluid within a reservoir, a second sensor configured to measure a concentration of the brake fluid, a third sensor configured to measure a temperature of the brake fluid, and a processor. The processor is configured to estimate the condition of the brake fluid from the fluid level, the concentration and the temperature and send a signal to a display, the signal indicative of the condition of the brake fluid.

### INTRODUCTION

The subject disclosure relates to brake fluids used in brakes on vehicles and, in particular, a method for determining a remaining life of a brake fluid based on continuous fluid level and quality measurements.

A brake system of an automobile or a vehicle is used to control and slow the rotation of wheels of the vehicle. An integral part of the brake system is a brake fluid that is used for hydraulic operation of a brake pad. The brake fluid can deteriorate over time, degrading the operation of the brake system. Current brake fluid sensors only provide an alarm when the brake fluid achieves a certain fluid level in its reservoir. Such sensors do not provide a thorough knowledge of the remaining usefulness of the brake fluid. Accordingly, it is desirable to provide a system and method that can determine a health of the brake fluid at any time in the life of the brake fluid.

### SUMMARY

In one exemplary embodiment, a method of monitoring a condition of a brake fluid is disclosed. A fluid level of the brake fluid within a reservoir is measured at a first sensor. A concentration of the brake fluid is measured at a second sensor. A temperature of the brake fluid is measured at a third sensor. The condition of the brake fluid is estimated from the fluid level, the concentration and the temperature at a processor. A signal is sent to a display, the signal being indicative of the condition of the brake fluid.

In addition to one or more of the features described herein, the method further includes determining a wear on a brake pad based on at least one of the condition of the fluid and a rate of depletion of the brake fluid. The condition of the brake fluid is at least one of a remaining useful life of the brake fluid, a presence of water in the brake fluid, a chemical composition of the brake fluid, and a level of oxidation of the brake fluid. Wherein the reservoir is disposed on a vehicle, the method further includes applying a filter to a measurement of the fluid level to compensate the measurement for a motion of the, wherein the filter is based on dynamics of the vehicle. The method further includes comparing the fluid level, the concentration and the temperature to at least one of simulated data and historical data. The method further includes detecting replacement of a brake pad from a discontinuity in the fluid level. Measuring the fluid level includes determining obtaining a plurality of measurements of the fluid level over time.

In another exemplary embodiment, a system for monitoring a condition of a brake fluid is disclosed. The system includes a first sensor configured to measure a fluid level of the brake fluid within a reservoir, a second sensor configured to measure a concentration of the brake fluid, a third sensor configured to measure a temperature of the brake fluid, and a processor. The processor is configured to estimate the condition of the brake fluid from the fluid level, the concentration and the temperature and send a signal to a display, the signal indicative of the condition of the brake fluid.

In addition to one or more of the features described herein, the processor is further configured to determine a wear on a brake pad based on at least one of the condition of the fluid and a rate of depletion of the brake fluid. The condition of the brake fluid is at least one of a remaining useful life of the brake fluid, a presence of water in the brake fluid, a chemical composition of the brake fluid, and a level of oxidation of the brake fluid. Wherein the reservoir is disposed on a vehicle, the processor is further configured to apply a filter to a measurement of the fluid level to compensate the measurement for a motion of the, wherein the filter is based on dynamics of the vehicle. The processor is further configured to compare the fluid level, the concentration and the temperature to at least one of simulated data and historical data. The processor is further configured to detect a replacement of a brake pad from a discontinuity in the fluid level. The first sensor is further configured to measure the fluid level by obtaining a plurality of measurements of the fluid level over time.

In yet another exemplary embodiment, a vehicle is disclosed. The vehicle includes a reservoir having a brake fluid therein, a first sensor configured to measure a fluid level of the brake fluid in the reservoir, a second sensor configured to measure a concentration of the brake fluid, a third sensor configured to measure a temperature of the brake fluid, and a processor. The processor is configured to estimate a condition of the brake fluid from the fluid level, the concentration and the temperature and send a signal to a display, the signal indicative of the condition of the brake fluid.

In addition to one or more of the features described herein, the processor is further configured to determine a wear on a brake pad based on at least one of the condition of the fluid and a rate of depletion of the brake fluid. The condition of the brake fluid is at least one of a remaining useful life of the brake fluid, a presence of water in the brake fluid, a chemical composition of the brake fluid, and a level of oxidation of the brake fluid. The processor is further configured to apply a filter to a measurement of the fluid level to compensate the measurement for a motion of the, wherein the filter is based on dynamics of the vehicle. The processor is further configured to compare the fluid level, the concentration and the temperature to at least one of simulated data and historical data. The processor is further configured to detect a replacement of a brake pad from a discontinuity in the fluid level.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIG. 2 shows a schematic view of a brake system of the vehicle, in an illustrative embodiment;

FIG. 3 shows a flow chart illustrating the operation of a brake fluid health monitor of the brake system, in an embodiment;

FIG. 4 shows a schematic diagram of a method for estimating a remaining life of a brake fluid;

FIG. 5 shows a graph illustrating normal brake fluid depletion over time;

FIG. 6 shows a schematic diagram of a method for estimating a brake pad wear;

FIG. 7 shows a graph illustrating the effects of brake pad replacement or other repair work on brake fluid levels;

FIG. 8 shows a graph illustrating brake fluid levels due to brake pad wear; and

FIG. 9 shows a diagram of a method for determining a condition for changing a brake pad.

### DETAILED DESCRIPTION

The following description is merely exemplary in nature and is not intended to limit the present disclosure, its application or uses. It should be understood that throughout the drawings, corresponding reference numerals indicate like or corresponding parts and features.

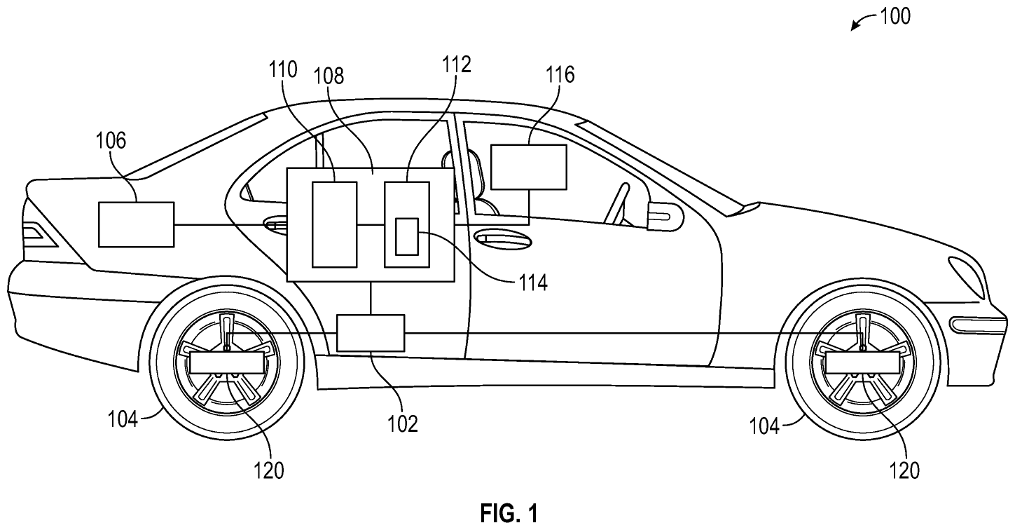

In accordance with an exemplary embodiment, FIG. 1 shows a vehicle 100. The vehicle 100 includes a brake system 102 configured to provide braking torque to one or more wheels 104. In operation, a force applied at the brake system 102 is transmitted to brake pads 120 at the one or more wheels 104 via a brake fluid. As disclosed herein, the brake system 102 also includes sensors for obtaining measurements of the brake fluid.

The vehicle 100 includes a vehicle dynamics sensor 106 that obtain measurements of dynamic parameters of the vehicle 100. The vehicle dynamics sensor 106 can refer to a plurality of dynamics sensors. The dynamic parameters can include, but are not limited to, a vehicle grade or incline of the vehicle from horizontal, a pitch of the vehicle, a roll of the vehicle, a yaw of the vehicle, a longitudinal acceleration of the vehicle, a lateral acceleration of the vehicle, and a commanded brake torque of the vehicle.

The vehicle 100 also includes a controller 108 that performs various operations at the vehicle. The brake system 102 and the vehicle dynamics sensor 106 are in communication with the controller 108 and provide their measurements to the controller. The controller 108 includes a processor 110 and a computer readable storage device or storage medium 112. The storage medium 112 includes programs or instructions 114 that, when executed by the processor 110, allow the processor to estimate a remaining life of the brake fluid based on the measurements obtained from the brake system 102 and from the vehicle dynamics sensor 106. The remaining life estimate can be sent to a display 116 to alert a user of a need for a brake pad change, brake fluid replacement or other maintenance procedure.

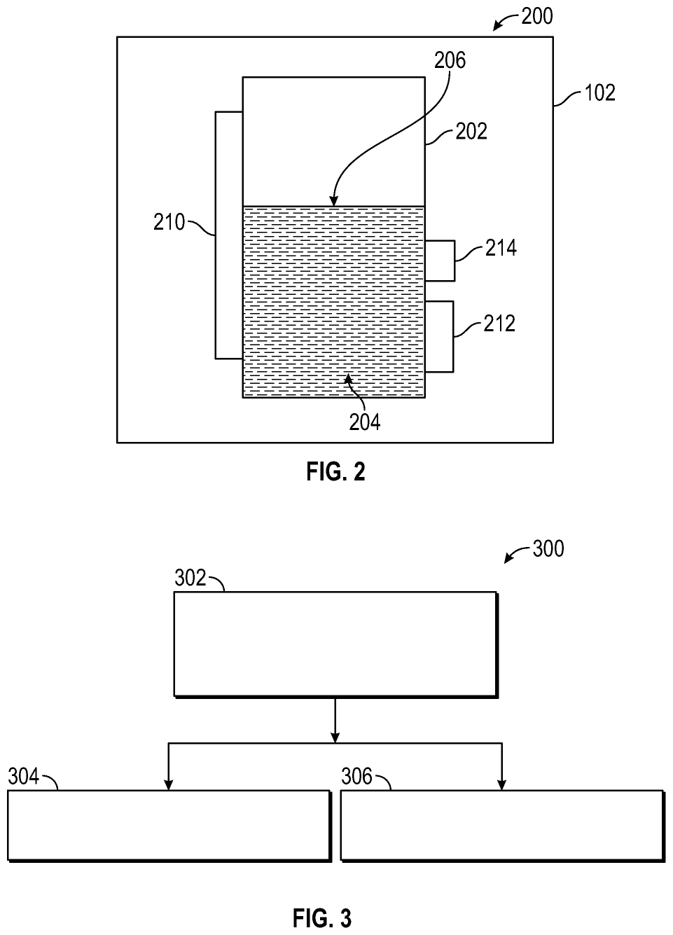

FIG. 2 shows a schematic view 200 of the brake system 102 in an illustrative embodiment. The brake system 102 includes a reservoir 202 that stores a brake fluid 204. The brake fluid 204 forms a meniscus 206 indicating a level or height of the brake fluid within the reservoir 202. Over time, the brake fluid 204 is depleted due to use of the brakes, resulting in lowering of the level of the meniscus 206 within the reservoir 202.

A fluid level sensor 210 (first sensor) is coupled to the reservoir 202 and measures the level of the brake fluid 204 within the reservoir 202. The fluid level sensor 210 is a continuous sensor. In other words, the fluid level sensor 210 measures a fluid level at any height within a range of fluid levels of the reservoir 202. The measurements can be obtained at a plurality of times. A fluid quality sensor 212 (second sensor) is also coupled to the reservoir 202. The fluid quality sensor 212 measures a concentration or chemical composition of the brake fluid 204. For example, the fluid quality sensor 212 can detect an amount of a foreign fluid, such as water or other contaminant, in the brake fluid 204. Also, the fluid quality sensor 212 can measure an amount of oxidation in the brake fluid 204 in the reservoir 202. The oxidation of the brake fluid indicates a degradation of the brake fluid. The presence of oxidized brake fluid lowers a boiling point of the brake fluid. The concentration of the brake fluid 204 can thus be used to determine an amount of contamination or deterioration of the brake fluid. The fluid quality sensor 212 is capable of concentration measurements at any selected time. A temperature sensor 214 (third sensor) is coupled to the reservoir 202 and is capable of measuring a temperature of the brake fluid 204 at any selected time. Understanding the temperature of the brake fluid 204 in combination with the concentration measurements allows one to determine the overall quality of the fluid at an instant in time. For example, the presence of water in the brake fluid 204 (due to its hydroscopic nature) under low temperatures can change the viscosity of the brake fluid, and therefore affect the sloshing behavior.

FIG. 3 shows a flow chart 300 illustrating the operation of the brake fluid health monitor, in an embodiment. In box 302, measurements are obtained of the fluid level (by fluid level sensor 210), a concentration of the brake fluid 204 (by fluid quality sensor 212), and a temperature of the brake fluid (by temperature sensor 214). In box 304, the measurements are used to estimate a remaining life of the brake fluid 204. In box 306, the measurements are used to estimate of the remaining life of the brake pad 120.

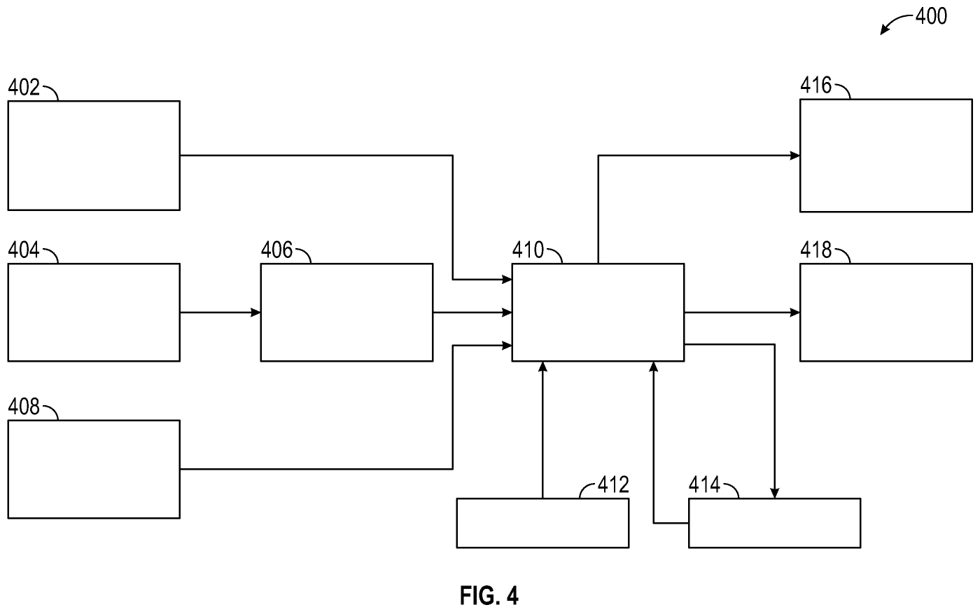

FIG. 4 shows a schematic diagram 400 of a method for estimating a remaining life of a brake fluid 204. The method includes determining the health status of the brake fluid 204 from the measurements made at the vehicle 100, including the measurements from the fluid level sensor 210, fluid quality sensor 212, fluid temperature sensor 214 and the dynamic parameters obtained from the vehicle dynamics sensor 106.

In box 402, the temporal measurements of the level of the brake fluid 204 are obtained. In box 404, the concentration/quality of the brake fluid is measured. In box 406, a brake fluid compatibility is determined from the brake fluid concentration and the brake fluid quality. The concentration sensor determines if the medium filling the brake system is in fact brake fluid based on a calibration made to a correct brake fluid concentration. Based on the fluid concentration measurement, it can be determined whether the correct type of brake fluid has been added to the reservoir 202. For example, if a foreign or unexpected fluid (such as an incompatible type of brake fluid, other automotive fluids, or water) is detected in the reservoir 202 by the quality sensor, it is important to flag this data (at box 406) before sending the data for use in the brake fluid health monitor algorithm (box 410). In box 408, temperature measurements are obtained from temperature sensor 214.

In box 410, the processor estimates a brake fluid condition from boxes 402, 404 and 408. The estimation of brake fluid condition can be based on a comparison of the brake fluid level, fluid concentration and temperature to data obtained from a simulation (box 412) and/or historical data (box 414). In box 412, a simulation is performed that determine normal fluid quality deterioration using a model. The measurements of boxes 402, 404 and 408 can be compared to the simulated data to estimate the brake fluid condition. Box 414 includes historical data from other in-field measurements. The measurements of boxes 402, 404 and 408 can be compared to the historical data to estimate the brake fluid condition. Additionally, the measurements of boxes 402, 404 and 408 can then be stored as historical data for future calculations.

In box 416, a signal can be sent (e.g., to the display 116) to indicate, based on the estimated brake fluid condition, that the brake fluid is incompatible with the vehicle 100 and that the vehicle should be serviced and the brake fluid replaced. In box 418, the estimate of the brake fluid condition can be used to estimate a remaining life of the brake fluid. The remaining life can be quantified in various dimensions, such as remaining distance (e.g., in kilometers), a percentage, and/or a remaining time.

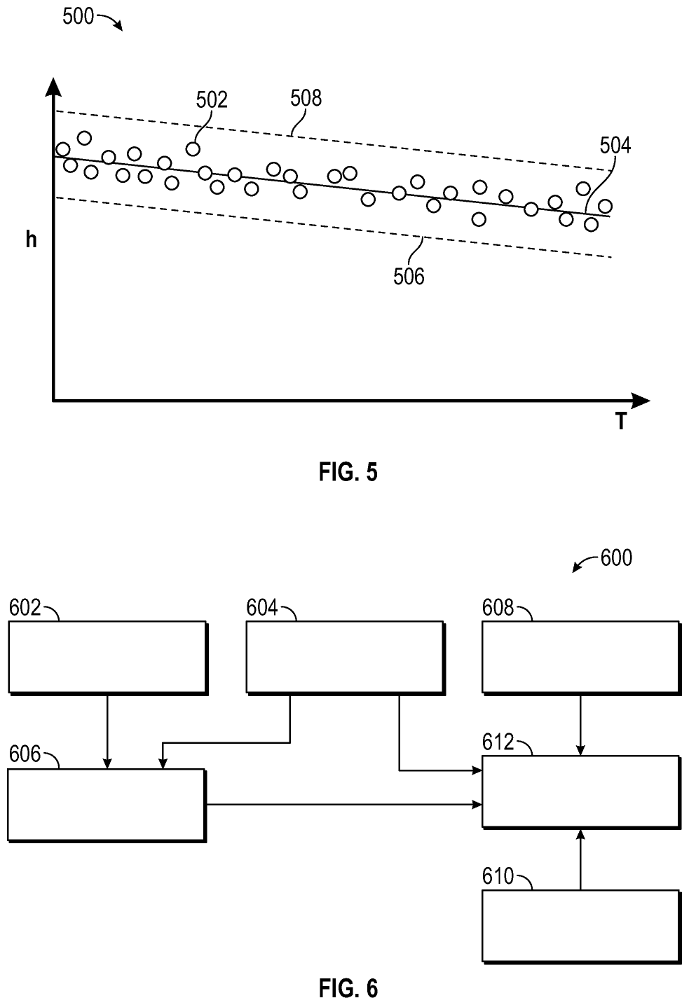

FIG. 5 shows a graph 500 illustrating normal brake fluid depletion over time. Time (T) is shown along the abscissa and brake fluid level (h) is shown along the ordinate axis. Time is generally shown over a “long” time frame, such as months or years. Data points 502 represent the fluid level at various times. A regression line 504 is determined for the data points 502 and a minimum boundary 506 and a maximum boundary 508 for the data points 502 is established. The minimum boundary 506 can be a deviation downward from the regression line 504, such as by one or two standard deviations. Similarly, the maximum boundary 508 can be a deviation upward from the regression line 504, such as by the same one or two standard deviations. The minimum boundary 506 and maximum boundary 508 can be used to establish a range of normal brake fluid depletion for the brake system 102.

FIG. 6 shows a schematic diagram 600 of a method for estimating a brake pad wear. In box 602, dynamic parameters of the vehicle are obtained. The dynamic parameters includes vehicle grade or inclination, pitch, roll, yaw of the vehicle, lateral/longitudinal acceleration, and brake torque. The vehicle grade is an angular deviation of the vehicle from horizontal and indicates an inclination angle of the meniscus of the fluid within the brake fluid reservoir. Similarly, the lateral and longitudinal acceleration of the vehicle, the pitch, roll, yaw, and braking torque are related to the level of disturbance of the fluid in the brake fluid reservoir.

In box 604, the brake fluid level in the brake fluid reservoir is measured. The brake fluid level is either a continuous measurement or a plurality of measurements obtained over time, or both.

In box 606 a slosh filter is applied to the brake fluid level measurements obtained in box 604. The slosh filter is based on the dynamic vehicle parameters obtained in box 602. The slosh filter outputs an adjusted brake fluid level that corrects fluid level measurements for the dynamic motion of the vehicle. Table 1 illustrates decision method for a slosh filter, in an illustrative embodiment.

TABLE 1

| Vehicle Data Type | Condition | Response |
|---|---|---|
| Vehicle grade (VG) | VG > (VG)ₘᵢₙthresh(cal) | Grade detected→cross |
| | and | reference grade |
| | VG < (VG)ₘₐₓthresh(cal) | compensation table |
| | | Proceed with standard |
| | | level measurement |
| Lateral/longitudinal | Lat/long accel > acc | Fluid level value |
| acceleration | threshold | comparison to |
| | | acceleration |
| | | compensation table |
| Commanded | If/else statement: | If true, expect sloshing |
| brake torque | Commanded brake | and level flutter |
| | torque >~0? | |

In a first row, the vehicle grade or incline is determined and, if above a threshold, is used to correct the fluid level measurements. In a second row, the lateral and/or longitudinal acceleration of the vehicle is measured. Corrections are made to the fluid level to account of the effects of the lateral and/or longitudinal acceleration on the fluid level measurement. In a third row, a commanded brake torque is measured. If the commanded brake torque is greater than or approximately zero, the filter is warned to expect sloshing of the brake fluid and to compensate for a flutter in the fluid level measurements.

The testing results obtained using Table 1 generate a slosh detection flag that indicates whether there is any amount of sloshing of the brake fluid 204 in the reservoir 202. In an embodiment, if the results of the slosh filter indicate that sloshing is expected, the measured data points (i.e., fluid level, etc.) can be recorded for historical data without making any immediate control changes based of the status of the brake fluid condition.

Box 608 includes a model that simulates normal brake pad wear over time given various usage scenarios. Box 610 includes historical data of brake pad wear for a given usage time for the brake pad 120. Box 612 receives the continuous fluid level measurements from box 604, the filtered brake fluid level from box 604, the simulated data from box 608 and the historical data from box 610 and estimates an amount of brake wear based on a comparison of the measurements to either the simulation data or the historical data or both.

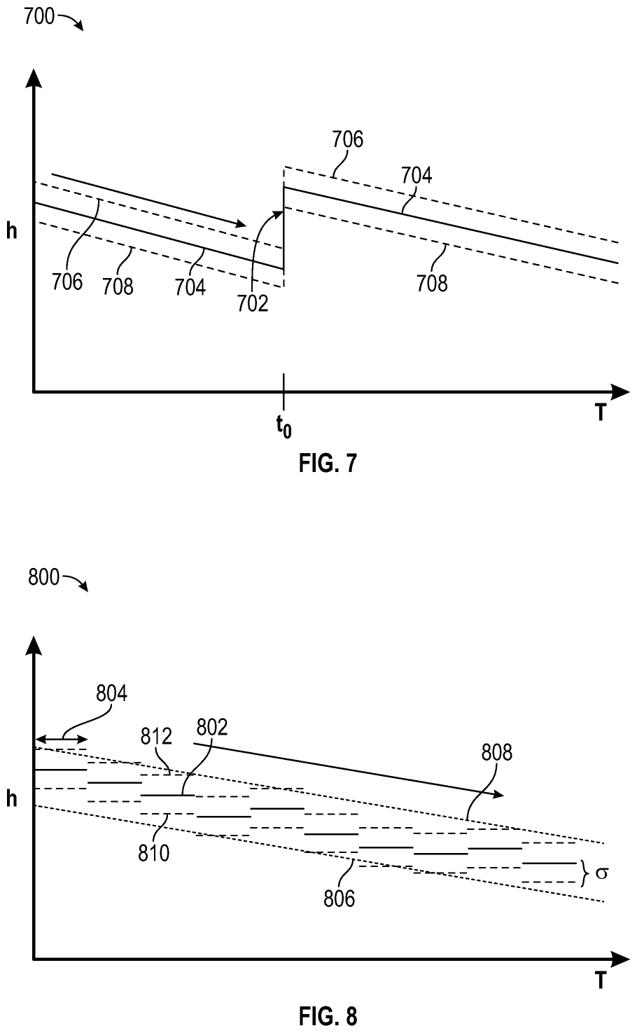

FIG. 7 shows a graph 700 illustrating the effects of brake pad replacement or other repair work on brake fluid levels. Time (T) is shown along the abscissa and brake fluid level (h) is shown along the ordinate axis. Time is generally shown over a “long” time frame, such as months or years. The brake pad replacement occurs at a time to. Thus, a discontinuity 702 occurs at a time to in the regression line 704 as well as the minimum boundary line 706 and maximum boundary line 708. The discontinuity can be due to a refilling of the brake fluid during the brake pad replacement. The discontinuity can be recognized by the processor 110, which can make an adjustment in order to provide consistent measurements of brake fluid levels and depletion rates.

FIG. 8 shows a graph 800 illustrating brake fluid levels due to brake pad wear. Time (T) is shown along the abscissa and brake fluid level (h) is shown along the ordinate axis. Time is generally shown over a “short” time frame. Fluid level measurements 802 are obtained over a plurality of drive cycles 804. Minimum boundary line 806 indicates an expected minimum fluid level for normal pad wear and maximum boundary line 808 indicates an expected maximum fluid level for normal pad wear. Lower deviation line 810 indicates an expected minimum range of data measurements due to brake pad wear, while upper deviation line 812 indicates an expected maximum range of data measurements due to brake pad wear. The fluid level decreases over time due to pad wear. The depletion rate can be determined from the graph 800 and used to indicate an amount of wear on the brake pad 120.

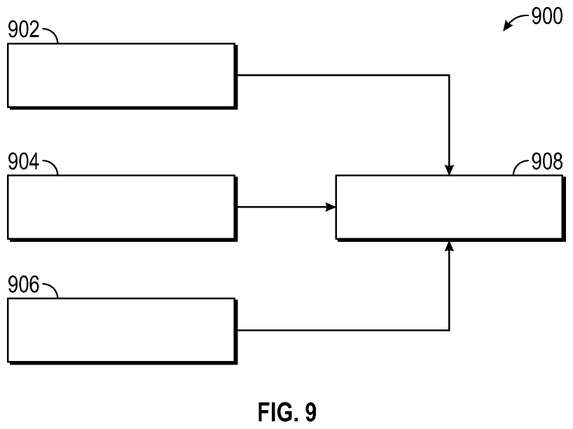

FIG. 9 shows a diagram 900 of a method for determining a condition for changing a brake pad 120. In box 902, continuous measurements of the brake fluid level are obtained. In box 904, a brake pad wear is estimated based on fluid level correlation. In box 906, a brake pad wear is estimated using a brake wear simulation model. In box 908, an indication of a need to change a brake pad 120 is made by the information from boxes 902, 904 and 906.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of monitoring a condition of a brake fluid, comprising:
measuring a fluid level of the brake fluid within a reservoir at a first sensor;
measuring a concentration of the brake fluid at a second sensor;
measuring a temperature of the brake fluid at a third sensor;
estimating, at a processor, the condition of the brake fluid from the fluid level, the concentration and the temperature; and
displaying a signal to a display, the signal indicative of the condition of the brake fluid.

2. The method of claim 1, further comprising determining a wear on a brake pad based on at least one of: (i) the condition of the fluid; and (ii) a rate of depletion of the brake fluid.

3. The method of claim 1, wherein the condition of the brake fluid is at least one of: (i) a remaining useful life of the brake fluid; (ii) a presence of water in the brake fluid; (iii) a chemical composition of the brake fluid; and (iv) a level of oxidation of the brake fluid.

4. The method of claim 1, wherein the reservoir is disposed on a vehicle, further comprising applying a filter to a measurement of the fluid level to compensate the measurement for a motion of the, wherein the filter is based on dynamics of the vehicle.

5. The method of claim 1, further comprising comparing the fluid level, the concentration and the temperature to at least one of: (i) simulated data; and (ii) historical data.

6. The method of claim 1, further comprising detecting replacement of a brake pad from a discontinuity in the fluid level.

7. The method of claim 1, wherein measuring the fluid level includes determining obtaining a plurality of measurements of the fluid level over time.

8. A system for monitoring a condition of a brake fluid, comprising:
a first sensor configured to measure a fluid level of the brake fluid within a reservoir;
a second sensor configured to measure a concentration of the brake fluid;
a third sensor configured to measure a temperature of the brake fluid;
a processor configured to estimate the condition of the brake fluid from the fluid level, the concentration and the temperature; and
send a signal to a display, the signal indicative of the condition of the brake fluid.

9. The system of claim 8, wherein the processor is further configured to determine a wear on a brake pad based on at least one of: (i) the condition of the fluid; and (ii) a rate of depletion of the brake fluid.

10. The system of claim 8, wherein the condition of the brake fluid is at least one of: (i) a remaining useful life of the brake fluid; (ii) a presence of water in the brake fluid; (iii) a chemical composition of the brake fluid; and (iv) a level of oxidation of the brake fluid.

11. The system of claim 8, wherein the reservoir is disposed on a vehicle and the processor is further configured to apply a filter to a measurement of the fluid level to compensate the measurement for a motion of the, wherein the filter is based on dynamics of the vehicle.

12. The system of claim 8, wherein the processor is further configured to compare the fluid level, the concentration and the temperature to at least one of: (i) simulated data; and (ii) historical data.

13. The system of claim 8, wherein the processor is further configured to detect a replacement of a brake pad from a discontinuity in the fluid level.

14. The system of claim 8, wherein the first sensor is further configured to measure the fluid level by obtaining a plurality of measurements of the fluid level over time.

15. A vehicle, comprising:
a reservoir having a brake fluid therein;
a first sensor configured to measure a fluid level of the brake fluid in the reservoir;
a second sensor configured to measure a concentration of the brake fluid;
a third sensor configured to measure a temperature of the brake fluid;
a processor configured to estimate a condition of the brake fluid from the fluid level, the concentration and the temperature; and
send a signal to a display, the signal indicative of the condition of the brake fluid.

16. The vehicle of claim 15, wherein the processor is further configured to determine a wear on a brake pad based on at least one of: (i) the condition of the fluid; and (ii) a rate of depletion of the brake fluid.

17. The vehicle of claim 15, wherein the condition of the brake fluid is at least one of: (ii) a remaining useful life of the brake fluid; (ii) a presence of water in the brake fluid; (iii) a chemical composition of the brake fluid; and (iv) a level of oxidation of the brake fluid.

18. The vehicle of claim 15, wherein the processor is further configured to apply a filter to a measurement of the fluid level to compensate the measurement for a motion of the, wherein the filter is based on dynamics of the vehicle.

19. The vehicle of claim 15, wherein the processor is further configured to compare the fluid level, the concentration and the temperature to at least one of: (i) simulated data; and (ii) historical data.

20. The vehicle of claim 15, wherein the processor is further configured to detect a replacement of a brake pad from a discontinuity in the fluid level.
